(19) United States
(12) Patent Application Publication
(10) Pub. No.: US 2012/0182278 A1
(43) Pub. Date: Jul. 19, 2012

(54) Methods and Apparatus for Estimating Light Adaptation Levels of Persons Viewing Displays

(75) Inventor: Anders Ballestad, Vancouver (CA)

(73) Assignee: DOLBY LABORATORIES LICENSING CORPORATION, San Francisco, CA (US)

(21) Appl. No.: 13/333,780

(22) Filed: Dec. 21, 2011

Related U.S. Application Data
(60) Provisional application No. 61/433,454, filed on Jan. 17, 2011.

(51) Int. Cl. G06F 3/038; G01J 1/44

(52) U.S. Cl. 345/207; 250/214 AL

(57) ABSTRACT

Methods and apparatus for estimating adaptation of the human visual system take into account the distribution of light detectors (rods and cones) in the human eye to weight contributions to adaptation from displayed content and ambient lighting. The estimated adaptation may be applied to control factors such as contrast and saturation of displayed content.

### CROSS REFERENCE TO RELATED APPLICATIONS

This application claims the benefit of priority to related, co-pending Provisional U.S. Patent Application No. 61/433,454 filed on 17 Jan. 2011, hereby incorporated by reference in its entirety.

### TECHNICAL FIELD

The invention relates to displays such as televisions, computer displays, cinema displays, special purposed displays and the like as well as to image processing apparatus and methods for processing image data for display. The invention relates specifically to apparatus and methods for estimating the adaptation level of viewers of the display.

### BACKGROUND

The human visual system (HVS) responds differently to light depending upon its degree of adaptation. Although the HVS is capable of perceiving an enormous range of brightness it cannot operate over its entire range at the same time. The sensitivity of the HVS adapts over time. This is called brightness adaptation. The level of brightness adaptation depends upon the recent exposure of the HVS to light. It can take up to 30 minutes or so for the HVS to be fully dark adapted. In the process of adapting to bright daylight to becoming dark adapted the HVS can become about 10⁶ times more sensitive.

It can be appreciated that the adaptation level of the HVS can have a very significant impact on the way in which a human viewer perceives visual information being presented to him or her. For example, the adaptation level can affect things such as the level perceived as white (white level), the level perceived as black (black level) and the perceived saturation of colors.

U.S. Pat. Nos. 7,826,681 and 7,782,405 describe displays that include adjustments based on ambient lighting. Other art in the field includes: Yoshida et al. (US 2001/0050757); Demos (US 2009/0201309); Nakaji et al. (US2002/0075136); and Kwon et al. High fidelity color reproduction . . . , IEEE Transactions on Consumer Electronics Vol. 55, No. 3, pp. 1015-1020 August 2009, IEEE 2009.

### SUMMARY OF THE INVENTION

The invention has a range of aspects. These include methods for estimating adaptation of the visual systems of viewers of displays, displays and other image processing apparatus and methods for controlling the display and/or transformations of images by displays and other image processing apparatus. The invention may be embodied, for example, in televisions, computer displays, cinema displays and/or specialized displays.

One aspect of the invention provides a method for estimating adaptation of a human visual system observing a display. The estimated adaptation may be applied to control mapping of pixel values in image data for display on the display, for example. The method comprises preparing a first estimate of light incident from a display screen on a human eye at a viewing location; preparing a second estimate of ambient light incident on the human eye from areas surrounding the display screen; and forming a weighted combination of the first and second estimates using a weight based on a relative proportion of light detectors in the human eye that receive light from the display screen to a proportion of light detectors in the human eye that receive light from the areas surrounding the display screen.

Another aspect of the invention provides a method for estimating a white-point for which a human visual system is adapted. The method comprises preparing a first estimate of the chromaticity of light incident from a display screen on a human eye at a viewing location; preparing a second estimate of the chromaticity of ambient light incident on the human eye from areas surrounding the display screen; and forming a weighted combination of the first and second estimates. The weighted combination is prepared using a weight based on a relative proportion of cones in the human eye that receive light from the display screen to a proportion of cones in the human eye that receive light from the areas surrounding the display screen.

Another aspect of the invention provides apparatus for estimating adaptation of a human visual system observing a display. The apparatus comprises an image processing module configured to determine from image data a first estimate of light incident from a display screen on a human eye at a viewing location. The apparatus also comprises an ambient light exposure module comprising an ambient light sensor and configured to determine a second estimate of ambient light incident on the human eye from areas surrounding the display screen. An adaptation estimation circuit is configured to form a weighted combination of the first and second estimates using a weight based on a relative proportion of light detectors in the human eye that receive light from the display screen to a proportion of light detectors in the human eye that receive light from the areas surrounding the display screen.

Another aspect of the invention provides apparatus for estimating adaptation of a human visual system observing a display. The apparatus comprises an angularly-selective light sensor oriented toward the display. The sensor is configured to measure incident light intensity as a function of angle φ away from an optical axis. The apparatus comprises a processing circuit configured to weight the measured incident light by a function f(φ) that approximates a distribution of light detectors in the human eye and to integrate the weighted measured incident light for a range of values of the angle φ.

Further aspects of the invention and features of specific embodiments of the invention are described below.

### BRIEF DESCRIPTION OF THE DRAWINGS

The accompanying drawings illustrate non-limiting embodiments of the invention.

FIG. 1 is a block diagram of a display according to an example embodiment of the invention.

FIG. 1A is a block diagram schematically illustrating an example adaptation estimation circuit.

FIG. 2 is a schematic drawing illustrating a model of a viewer watching a display.

FIG. 2A is a graph illustrating an approximation of the variation in density of light detectors (rods and cones) in the human eye as a function of angle.

FIG. 3 is a graph illustrating the variation in density of rod and cond light detectors with position on the human retina.

FIG. 4 is a flow chart illustrating a method according to an example embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

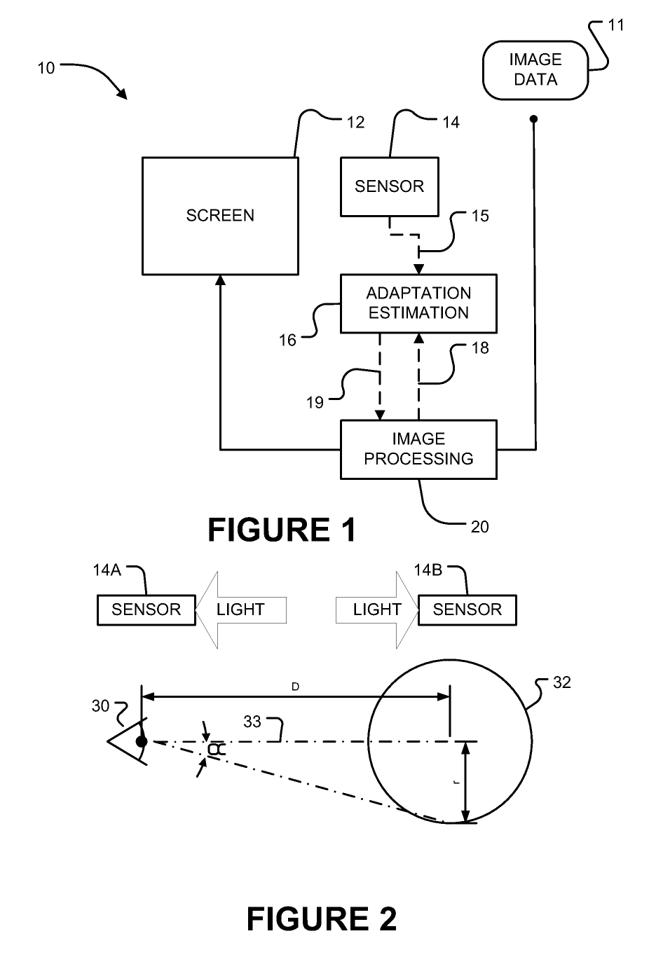

FIG. 1 shows a display 10 which includes a screen 12. Display 10 receives a signal 11 containing information specifying video or other images for display on screen 12 for viewing by a viewer. Signal 11 may comprise video data, for example. Display 10 comprises one or more sensors 14 which detect ambient light in the environment in which display 10 is being watched.

An adaptation estimation circuit 16 receives signals 15 from sensor(s) 14 and also receives one or more signals 18 that are representative of image content that has been or is being displayed on screen 12. Adaptation estimation circuit 16 may comprise inputs or registers that receive or store signals indicative of the luminance produced on screen 12 in response to specific pixel values in signal 11. The luminance may be a function of factors such as a setting of a brightness control or a current selected mode of operation of display 10 as well as a function of pixel values specified directly or indirectly by signal 11. Adaptation estimation circuit 16 processes signals 15 and 18 to obtain a value or values 19 indicative of the estimated adaptation level of the visual system of viewer V. Value or values 19 are supplied as control inputs to an image processing system 20 that processes image data from signal 11 for display on screen 12. Image processing system may adjust parameters specifying a black point, a white point, tone mapping parameters and/or other parameters in response to value(s) 19.

Adaptation estimation circuit 16 estimates adaptation of the HVS resulting from exposure to light from screen 12 as well as ambient light.

In a preferred embodiment, adaptation estimation circuit 16 takes into account the fact that the density of light detectors (rods and cones) in the HVS is not constant. Instead, light detectors are more dense in a central area of the retina (the fovea) and become less dense as one moves toward more peripheral parts of the retina. The maximum concentration of cones is roughly 180,000 per mm² in the fovea region. The density decreases outside of the fovea to a value of less than 5,000 cones/mm². This unevenness in the distribution of light detectors affects the relative contributions of ambient light and light from screen 12 to adaptation of the HVS.

FIG. 1A illustrates an example adaptation estimation circuit 16. Adaptation estimation circuit 16 comprises a screen luminance estimation circuit 16A configured to estimate an average luminance of screen 32 when driven to display an image specified by image data 11. An environment luminance estimation circuit 16B is configured to estimate an average ambient luminance from sensor signals 15. A weighted combiner 16C combines outputs from screen luminance estimation circuit 16A and environment luminance estimation circuit 16B according to weight(s) 17.

An output from weighted combiner 16C is time integrated by integrator 16D. Integrator 16D may, for example compute a weighted sum of the most-recent N outputs from weighted combiner 16C. An adaptation estimate 19 output by time integrator 16D is applied as a control input to a tone mapper 20A. Tone mapper 20A processes image data 11 for display on screen 32. Processed image data is applied to display driver 20B that drives screen 32.

Weight(s) 17 take into account the density of light detectors as a function of position on the human retina. Weights 17 may be preset. In some embodiments a display incorporates optional circuits 22 for determining weights 17 from inputs. FIG. 1A shows a user interface 22A which can receive a viewing distance 23 specified by a user. FIG. 1A also shows a range finder 22B that can measure a distance to a user (or to a device near the user). A weight calculator 24 computes weight(s) 17 based on the viewing distance 23 and the known dimensions of screen 23.

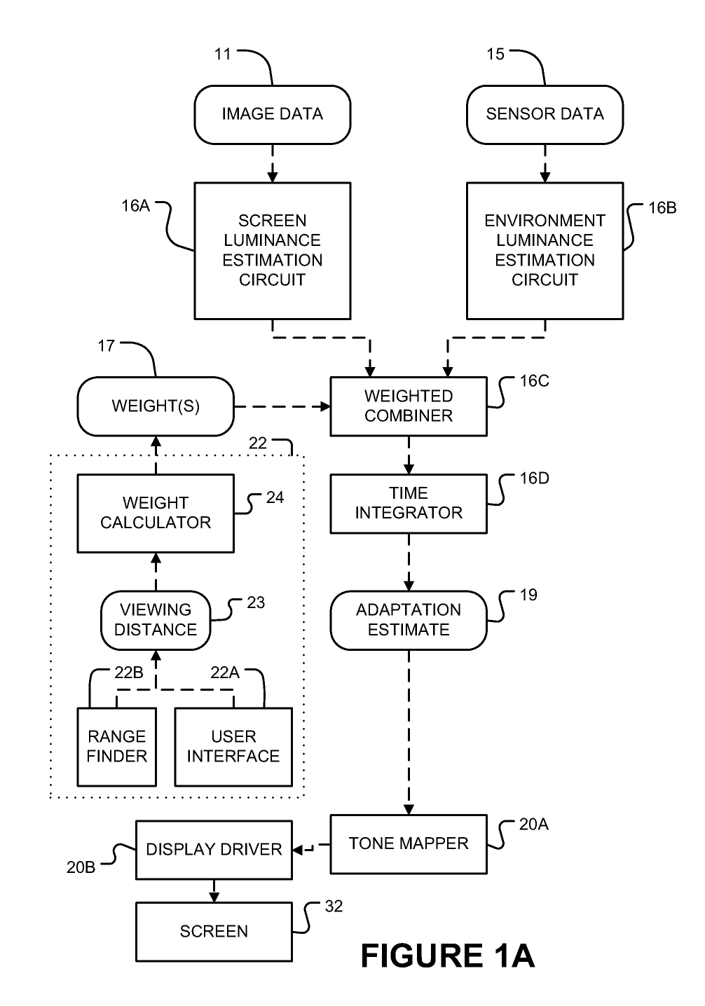

FIG. 2 illustrates schematically a viewer's eye 30 watching a screen 32 according to a greatly simplified model in which screen 32 is circular and the distribution of light detectors in the eye is indicated by a curve 34 (see FIG. 2A) which, in this simple model is symmetrical about the optical axis 33 of the eye. According to this model, the viewer is looking at the center of screen 32. The viewer is located a distance D of 4 times the screen radius, r, away from screen 32. This is a distance that is within the range of generally accepted guidelines for optimal viewing (for example, some guidelines recommend that the screen should subtend an angle of view in the range of 26 degrees to 36 degrees, other guidelines recommend viewing from a distance in the range of 2 to 5 times a width of the screen, other guidelines recommend a viewing distance of 1½ to 3 times a diagonal of the screen).

It can be seen from FIG. 2 that there is an angle α such that light incident on eye 30 at angles less than α comes from screen 32 whereas light incident on eye 30 at angles greater than a comes from outside of screen 32. The angle α is given by:

$$α = {tan}^{- 1} ( \frac{r}{D} ) \qquad ( 1 )$$

where D is the distance of eye 30 from screen 32 and r is the radius of screen 32. For example, in a case where the viewing distance D is three times the width of screen 32 then α is approximately 9½ degrees.

Given an estimate, such as curve 34, of the way in which light receptors are distributed in the viewer's eye, one can readily determine the proportion of the light receptors that receive light from screen 32 and the proportion of the light receptors that receive ambient light not coming from screen 32.

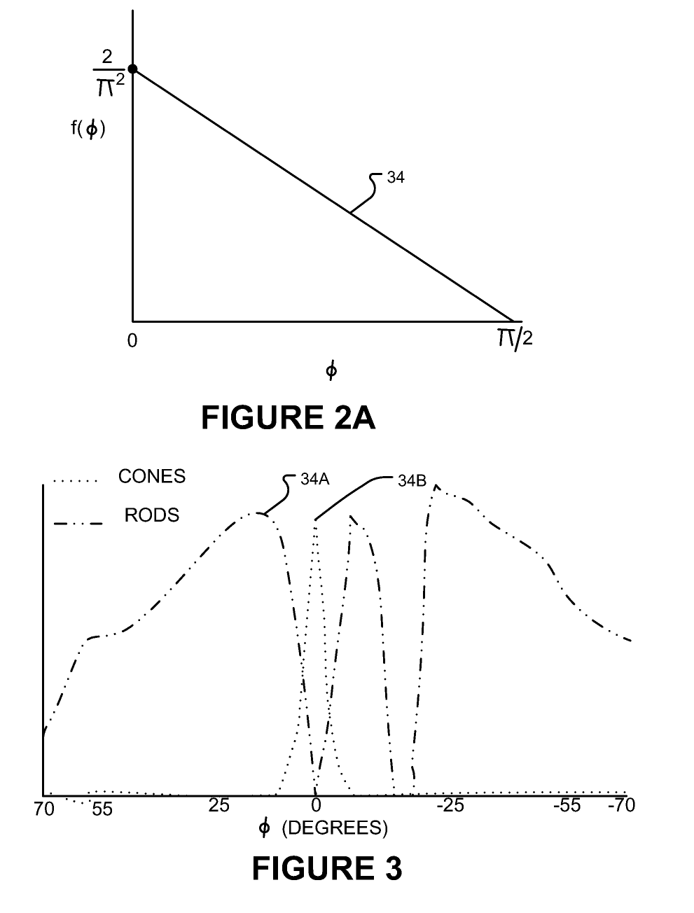

FIG. 3 is a graph which includes curves 34A and 34B which respectively illustrate the typical variation in density of rods and cones in a human eye as a function of angle away from the optical axis of the eye. Curve 34 may comprise a simplified model of curves 34A and 34B. For example. f(φ) may be chosen to be the function to represent an approximate density of light receptors in the human eye as a function of angle φ, with (φ=0 on the optical axis of the eye. In some embodiments, f(φ) can be expressed as:

$$f ( φ ) = \frac{2}{{π}^{2}} ( 1 - \frac{2}{π} φ ) \qquad ( 2 )$$

with 0<φ≦π.

Given a suitable function f(φ) where L(θ, φ) is the luminance detected by the eye incident from the direction (θ, φ) at a particular time then a measure, S, of the effect of the light incident on the adaptation of the human eye at that time may be given by:

S=∫_{θ=0}^{2π}∫_{φ=0}^{π}f(φ)L(θ,φ)dθdφ (3)

This calculation may be greatly simplified if it is assumed that the luminance of screen 32 does not vary spatially and also that the luminance of the ambient light does not vary spatially. In this case, average luminance values may be established for each of screen 32 and the ambient lighting. In this case:

$$L ( θ , φ ) = \{ \begin{matrix}{\overline{L}}_{amb} , & φ > α \\ {\overline{L}}_{disp} , & φ \leq α\end{matrix} \} \qquad ( 4 )$$

where L_{amb} is an average luminance of the ambient lighting, L_{disp} is an average luminance of screen 32, and α is the angle to the edge of screen 32 in radians, as defined above.

Using Equations (2), (3) and (4) one can derive the following estimate, S, of the effect of the light incident on the adaptation of the human eye:

$$\begin{matrix}S = {\overline{L}}_{amb} exp [ \frac{4 α}{π} ( 1 - \frac{α}{π} ) ln ( \frac{{\overline{L}}_{disp}}{{\overline{L}}_{amb}} ) ] \\ = {\overline{L}}_{amb} exp [ A ln ( \frac{{\overline{L}}_{disp}}{{\overline{L}}_{amb}} ) ]\end{matrix} \qquad ( 5 )$$

wherein A is a geometrical factor that may be fixed for a particular display and viewing distance. It can be seen that for α=0, S=L_{amb} and for α=π, S=L_{disp}. For 0<α<π, S is a weighted combination of L_{amb} and L_{disp}. S can be integrated over historical values for S to arrive at an estimate of the current adaptation level of eye 30.

In some embodiments, light exposure of eye 30 is estimated separately for light from screen 32 and light from outside of screen 32 and these exposures are combined according to a weighted average in which the weighting at least approximately reflects the relative proportion of the light receptors that receive light from screen 32 to the proportion of the light receptors that receive ambient light not coming from screen 32.

The light exposure from screen 32 may be estimated in various ways. It can be desirable to determine both the chromaticity and brightness of the light exposure as some models of the HVS take chromaticity into account. Additionally, in some embodiments gamut transformations are performed so that the displayed image data has a white point matching that to which a viewer has adapted (taking into account both ambient lighting and lighting from the displayed images).

In some embodiments, the light exposure is estimated based on illumination characteristics of a selected region within screen 32. The selected region is assumed to be representative of the screen as a whole. For example, the average luminance or the average luminance and white point may be determined for the selected region. A geometric mean of the luminance of the display may, for example, be used as the average luminance. The geometric mean my be given, for example, by:

$${L}_{av} = exp ( \frac{1}{n} {\sum }_{i = 1}^{n} ln ( {L}_{i} ) ) \qquad ( 6 )$$

where Lₐᵥ is the geometric mean, n is the number of pixels in the selected region, I is an index and Lᵢ is the brightness of each pixel.

The selected region may, for example, be a region at or near the center of screen 32. In other embodiments illumination characteristics are determined for the entire screen 32. For example, the average luminance or the average luminance and white point may be determined for the entire screen 32.

In still other embodiments, illumination characteristics are determined for each of a plurality of regions within screen 32. These regions may be selected to correspond to different densities of light receptors in eye 30. For example, the regions may comprise concentric rings centered on screen 32 or vertical stripes at different distances from the center of screen 32 or the like. In such embodiments, light exposures for different regions of the plurality of regions may be weighted based upon the relative proportions of light sensors in eye 30 that would receive light from those regions (assuming that the user is looking at the center of screen 32). This may result in a different weighting for each of the plurality of regions.

In still other embodiments, illumination characteristics are determined for regions of screen 32 that are selected dynamically to be at the location of or at the estimated location of the center of gaze of eye 30 from time to time. For example, images in signal 11 may be processed to identify moving objects that would be expected to attract eye 30 or a gaze detection system 35 may be provided to determine the actual direction of a viewer's gaze. Weights for one or more regions may be based at least in part on the density of light sensors in the portion of the viewer's retina receiving light from that region.

In still other embodiments, illumination characteristics are determined for screen 32 according to an averaging function in which the luminance of pixel values is weighted according to pixel location by f(φ).

Some embodiments estimate reflections of ambient light from screen 32 and include the estimates of such reflections in the estimated illumination by screen 32. Such reflections may be estimated from measurements of the ambient light by sensor(s) 14 and the known optical characteristics of screen 32. In some embodiments a signal representing measured ambient light is multiplied by a factor which is determined empirically or based on knowledge of the optical characteristics of screen 32 to obtain an estimate of reflected light that is added to the luminance created by the display of images on screen 32. In some embodiments, an ambient light sensor 14B (see FIG. 2A) is oriented to directly detect ambient light incident on screen 32 from the direction of the viewer and an estimate of the reflected light is determined from the output of sensor 14B.

Sensor(s) 14 may be positioned to monitor ambient light without receiving light directly from screen 32. Sensor(s) 14 may monitor both the brightness of ambient light and chromaticity (e.g. white point) of the ambient light.

It can be appreciated that the proportions of light receptors that are exposed to light from screen 32 and ambient light not from screen 32 will depend on the viewing distance. The viewing distance may be any of:
estimated based on a dimension of screen 32 (e.g. the viewing distance may be assumed to be 2 or 3 times a width of screen 32);
determined from user input (e.g. a display may provide a user interface that allows a user to set a viewing distance);
measured (e.g. a range finder or stereo camera may be configured to measure a distance to a viewer); or
inferred (e.g. a distance to a remote control or other accessory associated with the display that would be expected to be co-located with a viewer may be measured by way of a suitable range finding technology).

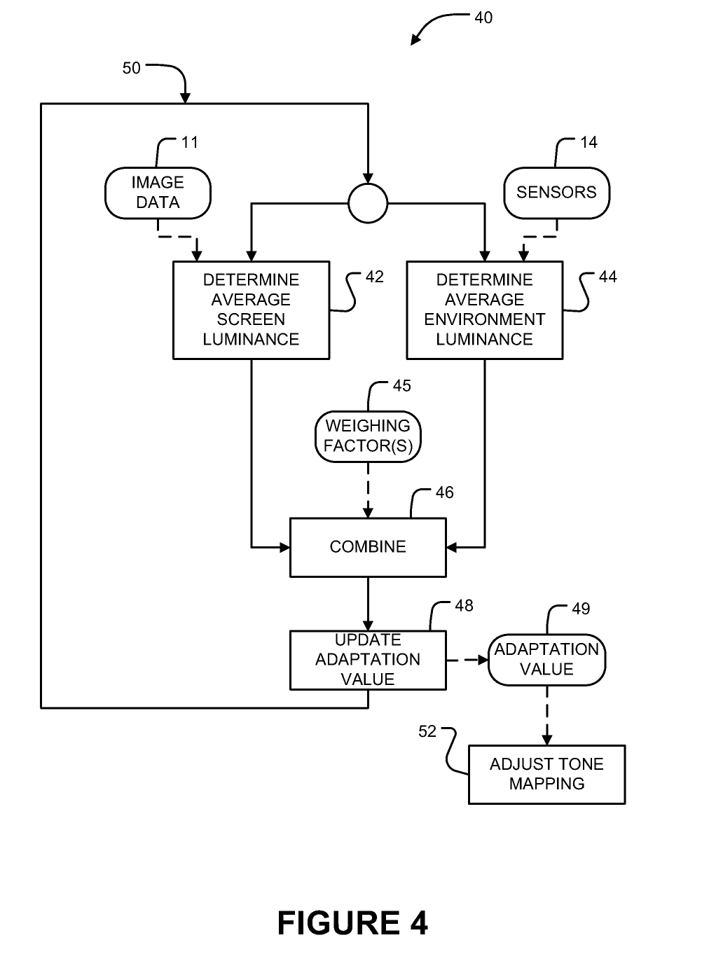

FIG. 4 illustrates a method 40 according to an example embodiment. In block 42 method 40 determines a current average luminance of screen 32 by processing image data or statistics derived from image data. In block 44 method 40 determines an average luminance of ambient light based on a signal or signals from sensor(s) 14.

In block 46 the average luminances from blocks 42 and 44 are combined using weighting factors 45. Weighting factors 45 are such that the average luminances from blocks 42 and 44 are combined in approximate proportion to the relative numbers of light sensors in eye 30 that would receive light from screen 32 and the surroundings of screen 32 respectively.

In block 48 a value 49 representing the estimated adaptation level of viewers' eyes is updated. Block 48 may comprise, for example, taking a weighted average of the most recent N values output by block 46. In some embodiments, more recent values are weighted more heavily than older values. Loop 50 comprising blocks 42, 44, 46, and 48 may be repeated continuously so as to keep estimate 49 of the adaptation level of viewers' eyes continually updated.

In block 52, parameters of a tone mapping circuit are adjusted based upon estimate 49. For example, block 52 may adjust parameters affecting contrast and/or saturation in tone mapping curves being applied to process images for display on screen 32. For example:
saturation may be increased when estimate 49 indicates that eyes 30 are more light adapted and decreased when estimate 49 indicates that eyes 30 are more dark adapted;
tone mapping may be performed in a manner which maps to brighter (greater luminance) values when estimate 49 indicates that eyes 30 are more light adapted and maps to dimmer (lower luminance) when estimate 49 indicates that eyes 30 are more dark adapted.

In some embodiments, better estimations of adaptation level are obtained taking into account the locations of light sources in the environment. The locations of light sources may be determined, for example, by providing multiple light sensors 14 that sample light incident from multiple corresponding locations within the environment. In some embodiments, luminance detected by such sensors is weighted taking into account the retinal response of the human visual system (e.g. weighted based on how far ‘off axis’ the light is at the location of a viewer).

Embodiments of the invention may optionally provide ambient light sensor(s) 14A (see FIG. 2A) that are located near a viewer and measure incident light originating from the direction of screen 32. In some embodiments, such sensors monitor incident light as a function of angle φ from an optical axis centered on screen 32. In such embodiments, adaptation may be estimated by taking a average of the luminance detected by sensor(s) 14A for different angles of incidence φ that is weighted by a factor f(φ) which reflects the density of light detectors in the human eye. The average may be taken, for example, according to Equation (3).

In some embodiments, tone and gamut mapping are performed such that a white point of displayed images is selected to match the chromatic white point of the viewing environment. In some embodiments the chromatic white point of the viewing environment is estimated taking into account the distribution of cones on the human retina (cones sense chromaticity while rods do not).

Certain implementations of the invention comprise computer processors which execute software instructions which cause the processors to perform a method of the invention. For example, one or more processors in a display or image processing device may implement a method as illustrated in FIG. 4 by executing software instructions in a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for estimating adaptation of a human visual system observing a display, the method comprising:
preparing a first estimate of light incident from a display screen on a human eye at a viewing location;
preparing a second estimate of ambient light incident on the human eye from areas surrounding the display screen;
forming a weighted combination of the first and second estimates using a weight based on a relative proportion of light detectors in the human eye that receive light from the display screen to a proportion of light detectors in the human eye that receive light from the areas surrounding the display screen.

2. A method according to claim 1 wherein preparing the first estimate comprises determining an average luminance of the display screen.

3. A method according to claim 2 wherein the average luminance comprises a geometric mean of the luminance of pixels of the display screen.

4. A method according to claim 2 comprising generating the second estimate based on a signal from an ambient light sensor.

5. A method according to claim 4 wherein the ambient light sensor is located at the display screen.

6. A method according to claim 4 wherein the ambient light sensor comprises a sensor located at the viewing location and oriented toward the display screen.

7. A method according to claim 4 wherein the weighted combination is given by:
$$S = {\overline{L}}_{amb} exp [ \frac{4 α}{π} ( 1 - \frac{α}{π} ) ln ( \frac{{\overline{L}}_{disp}}{{\overline{L}}_{amb}} ) ] \pm 10 \%$$
where S is the weighted combination, L_{amb} is the second estimate, L_{disp} is the first estimate, and α is an angle subtended at the viewing position from the center of the screen to an edge of the screen.

8. A method according to claim 2 wherein the first estimate comprises an estimate of light reflected from the screen.

9. A method according to claim 8 comprising determining the estimate of light reflected from the screen by multiplying a value representing ambient light detected by the ambient light sensor by a predetermined factor.

10. A method according to claim 1 wherein the density of the light detectors in the human eye is approximated as a linear function of an angle of incidence relative to an optical axis of the eye.

11. A method according to claim 10 wherein the density is approximated by the equation:
$$f ( φ ) = \frac{2}{{π}^{2}} ( 1 - \frac{2}{π} φ )$$
where φ is the angle of incidence relative to an optical axis of the eye expressed in radians and f(φ) is the approximated density of the light detectors in the human eye.

12. A method according to claim 1 comprising setting the weight based on a distance to the viewing location.

13. A method according to claim 12 comprising receiving a value indicative of the distance to the viewing location by way of a user interface and basing the weight on the received value.

14. A method according to claim 12 comprising determining a distance to the viewing location by means of a range finder and basing the weight on a value output by the rangefinder.

15. A method according to claim 12 comprising measuring a distance between the display and a remote control for the display and basing the weight on the measured distance.

16. A method according to claim 1 comprising integrating the weighted combination over a period to provide an adaptation estimate.

17. A method according to claim 16 comprising applying the adaptation estimate to control a mapping of input image data for display on the screen.

18. A method according to claim 17 comprising applying the adaptation estimate to control a parameter that affects saturation of colors in images displayed on the screen.

19. A method according to claim 17 comprising applying the adaptation estimate to control a parameter that affects contrast in images displayed on the screen.

20. A method according to claim 1 further comprising estimating a white-point for which a human visual system is adapted, the method comprising:
preparing a third estimate of the chromaticity of the light incident from the display screen on the human eye;
preparing a fourth estimate of the chromaticity of the ambient light incident on the human eye from areas surrounding the display screen;
forming a weighted combination of the third and fourth estimates using a weight based on a relative proportion of cones in the human eye that receive light from the display screen to a proportion of cones in the human eye that receive light from the areas surrounding the display screen.

21. A method according to claim 20 comprising applying the weighted combination of the third and fourth estimates to control a gamut mapping of the image data such that a white point of images displayed on the screen matches the weighted combination of the third and fourth estimates.

22. A method for estimating a white-point for which a human visual system is adapted, the method comprising:
preparing a first estimate of the chromaticity of light incident from a display screen on a human eye at a viewing location;
preparing a second estimate of the chromaticity of ambient light incident on the human eye from areas surrounding the display screen;
forming a weighted combination of the first and second estimates using a weight based on a relative proportion of cones in the human eye that receive light from the display screen to a proportion of cones in the human eye that receive light from the areas surrounding the display screen.

23. Apparatus for estimating adaptation of a human visual system observing a display, the apparatus comprising:
an image processing module configured to determine from image data a first estimate of light incident from a display screen on a human eye at a viewing location;
an ambient light exposure module comprising an ambient light sensor and configured to determine a second estimate of ambient light incident on the human eye from areas surrounding the display screen;
and an adaptation estimation circuit configured to form a weighted combination of the first and second estimates using a weight based on a relative proportion of light detectors in the human eye that receive light from the display screen to a proportion of light detectors in the human eye that receive light from the areas surrounding the display screen.

24. Apparatus according to claim 21 wherein the image processing module is configured to determine an average luminance of the display screen.

25. Apparatus according to claim 24 wherein the image processing module is configured to determine a geometric mean of the luminance of pixels of the display screen.

26. Apparatus according to claim 24 wherein the image processing module is configured to determine the average luminance according to an averaging function in which the luminance of pixel values is weighted according to pixel location by a function f(φ) that approximates a distribution of light detectors in the human eye.

27. Apparatus according to claim 23 comprising a user interface configured to accept a value indicating a viewing distance wherein the weight is set based at least in part on the value indicating the viewing distance.

28. Apparatus according to claim 23 comprising range finder configured to measure a distance to a viewer and output a signal indicating the distance to the viewer wherein the weight is set based at least in part on the measured distance to the viewer.

29. Apparatus according to claim 23 comprising range finder configured to measure a distance to a remote control associated with the display and output a signal indicating the distance to the remote control wherein the weight is set based at least in part on the measured distance to the remote control.

30. Apparatus according to claim 23 wherein the ambient light sensor comprises a sensor located at the viewing location and oriented toward the display screen.

31. Apparatus according to claim 23 comprising a tone mapper configured to perform tone mapping on image data for display on the display screen wherein the tone mapper is configured to perform contrast compression on the image data and an output of the adaptation estimation circuit is connected to control an amount of the contrast compression.

32. Apparatus according to claim 23 comprising a tone mapper configured to perform tone mapping on image data for display on the display screen wherein the tone mapper is configured to adjust color saturation of the image data and an output of the adaptation estimation circuit is connected to control the adjustment of the color saturation.

33. Apparatus for estimating adaptation of a human visual system observing a display, the apparatus comprising:
an angularly-selective light sensor oriented toward the display, the sensor configured to measure incident light intensity as a function of angle φ away from an optical axis; and a processing circuit configured to weight the measured incident light by a function f(φ) that approximates a distribution of light detectors in the human eye and to integrate the weighted measured incident light for a range of values of the angle φ.
